(19) United States
(12) Patent Application Publication
(10) Pub. No.: US 2012/0193090 A1
(43) Pub. Date: Aug. 2, 2012

(54) DOWNHOLE SENSOR ASSEMBLY

(76) Inventor: Jorge E. Lopez De Cardenas, Houston, TX (US)

(21) Appl. No.: 13/305,587

(22) Filed: Nov. 28, 2011

(30) Foreign Application Priority Data
Nov. 30, 2010 (MX) MX/A/2010/013155

(51) Int. Cl. E21B 47/00; G01Q 10/00

(52) U.S. Cl. 166/250.01; 166/66

(57) ABSTRACT

The current application discloses assemblies and methods for monitoring the downhole condition of a subterranean formation subject to a treatment such as hydraulic fracturing. The method comprises deploying a sensor to a position proximate to the treatment zone of the subterranean formation, maintaining the sensor below or within the flow path of the treatment fluid applied to the treatment zone, and recording a measurement by the sensor. In some cases, the sensor is hosted in an elongated housing and the outer diameter of the elongated housing is about 10% to about 70% of the inner diameter of the flow path of the treatment fluid applied to the treatment zone. In some cases, the flow rate of the treatment fluid is controlled. Therefore, the conveyance device of the sensor can be protected from damage or breakage caused by the erosion, jetting effects or drag force of the treatment fluid.

### CROSS-REFERENCE TO RELATED APPLICATION

The current application is based on and claims the benefit of priority from Mexican Patent Application No. MX/a/2010/013155, filed on Nov. 30, 2010; the entire contents of which are hereby incorporated by reference.

### FIELD OF THE APPLICATION

The current application is generally related to downhole sensors and downhole sensor assemblies for use in the field of oil and gas or geothermal exploration or production, although embodiments disclosed herein may be applicable in other fields as well.

### BACKGROUND

The statements in this section merely provide background information related to the present disclosure and may not constitute prior art. The entire contents of the references discussed herein are incorporated by reference into the current application.

During oilfield operations such as hydraulic fracturing, it is desirable to monitor the conditions and parameters of the operation. This is normally achieved by sensors placed at the surface around the wellhead. However, monitoring the condition and parameters downhole at a location proximate to the treatment zone is more advantageous because it can provide more accurate reading on the progress and status of the operation, and additional information to evaluate the fracture and downhole properties of the fluids being injected or produced.

Several attempts have been made to address this problem. U.S. Pat. No. 7,543,635 discloses a system and method for monitoring the downhole condition of a fracturing operation by connecting a set of sensors to a downhole tool such as a frac plug, a bridge plug, or a packer. To minimize damages to the sensors by the abrasive fracturing fluid, in U.S. Pat. No. 7,543,635, the sensors are carefully positioned out of the flow path of the fracturing fluid. However, the isolation of the sensors from the fracturing fluid prevents the sensors from obtaining accurate readings on a fracturing operation.

U.S. Pat. No. 4,898,241 discloses a system for monitoring the condition of a subterranean formation. Specifically, in U.S. Pat. No. 4,898,241, a monitoring device such as a seismic geophone is deployed near an uncased subterranean formation to monitor the geophysical condition of the subterranean formation during a fracturing operation. To minimize the impact of the casing vibration and fluid fluctuation on the monitoring device, the monitoring device in U.S. Pat. No. 4,898,241 is “decoupled” from the casing of the wellbore and positioned away from the flow path of the fracturing fluid.

U.S. Pat. No. 6,543,538 and U.S. Pat. No. 6,672,405 disclose methods and assemblies for performing multi-stage stimulation operations by alternatively discharging perforating guns and dropping sealing balls into the wellbore so that multiple layers of subterranean formations can be treated stage by stage. However, in U.S. Pat. No. 6,543,538 and U.S. Pat. No. 6,672,405, sensors are not described or disclosed.

There remains a need to more accurately monitor the downhole condition of an oilfield operation.

### SUMMARY

According to one aspect, there is provided an assembly which comprises a sensor hosted in an elongated housing, a conveyance device that is attached to the elongated housing at one end and to a surface of a wellbore at another end, where the outer diameter of the elongated housing is about 10% to about 70% of the inner diameter of the flow path of a treatment fluid applied to the wellbore. In some cases, the outer diameter of the elongated housing is about 20% to 60% of the inner diameter of the flow path of the treatment fluid applied to the wellbore. In some other cases, the outer diameter of the elongated housing is about 30% to 50% of the inner diameter of the flow path of the treatment fluid applied to the wellbore. In some further cases, the outer diameter of the elongated housing is about 40% of the inner diameter of the flow path of the treatment fluid applied to the wellbore. In some additional cases, the sensor assembly further comprises a blast joint located proximate to an entry of the treatment fluid so as to prevent the treatment fluid from directly impacting the conveyance device by erosion or jetting actions. The conveyance device can be coiled tubing, wireline, slickline, cable, or the like.

According to another aspect of the application, there is provided a method of monitoring a downhole condition proximate to a treatment zone of a subterranean formation. The method comprises deploying a sensor to a position proximate to the treatment zone of the subterranean formation; maintaining the sensor below or within a flow path of a treatment fluid applied to the treatment zone; and recording a measurement by the sensor. In some cases, the sensor is in physical contact with the wall of the wellbore. In some other cases, the sensor floats in the stream of the treatment fluid. The sensor measures, for example, one or more of a temperature, a pressure, a viscosity, a density, and a flow rate of the treatment fluid applied to the subterranean formation, but other parameters of interest could be measured as well. In some cases, the sensor is hosted in an elongated housing and the outer diameter of the elongated housing is about 10% to about 70% of the inner diameter of the flow path of the treatment fluid applied to the treatment zone.

### BRIEF DESCRIPTION OF THE DRAWINGS

These and other features and advantages will be better understood by reference to the following detailed description when considered in conjunction with the accompanying drawings. The drawings are provided for illustrative purposes only and should not be construed as limitations to the application. Objects in the drawings are not drawn to scale.

FIG. 1 is a cross sectional view of a downhole sensor assembly according to one embodiment of the current application.

FIG. 2 is a cross sectional view of a downhole sensor device according to one embodiment of the current application.

FIG. 3 is a flow chart illustrative one method of using the downhole sensor device of the current application.

### DETAILED DESCRIPTION OF SOME ILLUSTRATIVE EMBODIMENTS

The following description illustrates embodiments of the application by way of example and not by way of limitation. All numbers disclosed herein are approximate values unless stated otherwise, regardless whether the word “about” or “approximately” is used in connection therewith. The numbers may vary by up to 1%, 2%, 5%, or sometimes 10% to 20%. Whenever a numerical range with a lower limit and an upper limit is disclosed, any number falling within the range is specifically and expressly disclosed.

Moreover, as used herein, terms such as “up”, “down”, “upper”, “lower”, “top” and “bottom” and other like terms indicate relative positions of the various embodiments of the downhole sensor and assembly of the present application with the conveyance mechanism (such as a cable, a coiled tubing, a wireline, a slickline, etc.) and the downhole sensor vertically oriented as shown in the drawings. However, it should be borne in mind that the downhole sensor and assembly of the present application can be used in wells having wellbore sections that are oriented vertically, that are highly deviated from the vertical, or may be oriented horizontally. When applied to equipment and method for use in wells that are deviated or horizontal, such terms may refer to a left to right, right to left, or other relationship as appropriate.

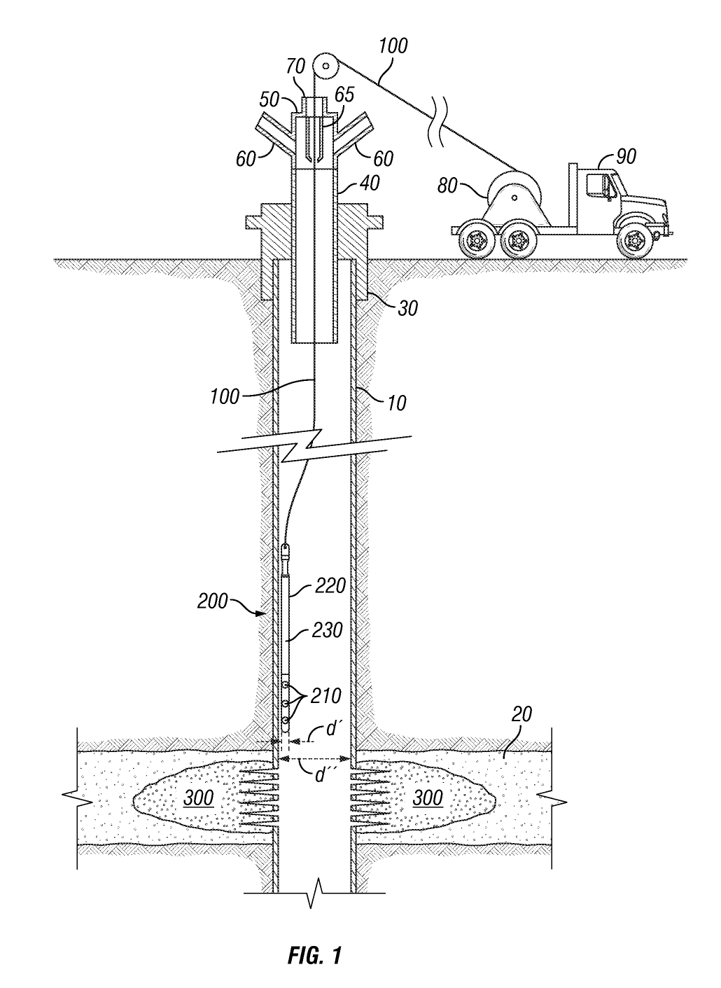

FIG. 1 shows one embodiment of the present application where a wellbore 10 is drilled from the surface of an oilfield to penetrate a subterranean formation 20. The wellbore 10 is equipped with a blowout preventer (BOP) 30 at the ground level to control the high pressure from the wellbore. During an oilfield operation, a treatment pipe 40 can be inserted through the BOP 30 into the wellbore 10, through which treatment fluids can be introduced into the wellbore 10.

A treatment head 50 can then be positioned on top of the treatment pipe 40. The treatment head 50 may have at least one conduit 60 extending from the side wall of the stinger blast joint 50. During an oilfield operation, treatment fluids can be fed into the conduit 60 and then passed down the wellbore 10 to the subterranean formation 20. The treatment head 50 may further contain a lubricator/BOP 70 affixed at the top of the treatment head 50, through which a conveyance device 100, a sensor assembly 200, or a bottom hole assembly (BHA), etc. can be introduced into the wellbore 10.

The conveyance device 100 can be any device commonly used in the oilfield to deliver tools to a downhole location. Examples of the conveyance device 100 include, but are not limited to, wireline, slickline, cable, and coiled tubing, etc. The conveyance device 100 is typically deployed at the wellsite by surface equipment 90 such as a truck or a skid. A reel or winch 80 is mounted on the surface equipment 90, around which the conveyance device 100 is spooled.

To reduce damages to the conveyance device 100 caused by the treatment fluid gushing into the treatment head 50 via the conduit 60, a blast joint 65 can be installed inside the treatment head 50 at a location where the conduit 60 enters the treatment head 50. The blast joint 65 can shield the conveyance device 100 from the erosion or jetting action of the treatment fluid. Alternatively, or in combination with the blast joint 65, the conduit 60 can be arranged in such a manner that the projected pathway of the treatment fluid is offset from the center of the treatment head 50, therefore the jetting action of the treatment fluid does not impact the conveyance device 100 directly.

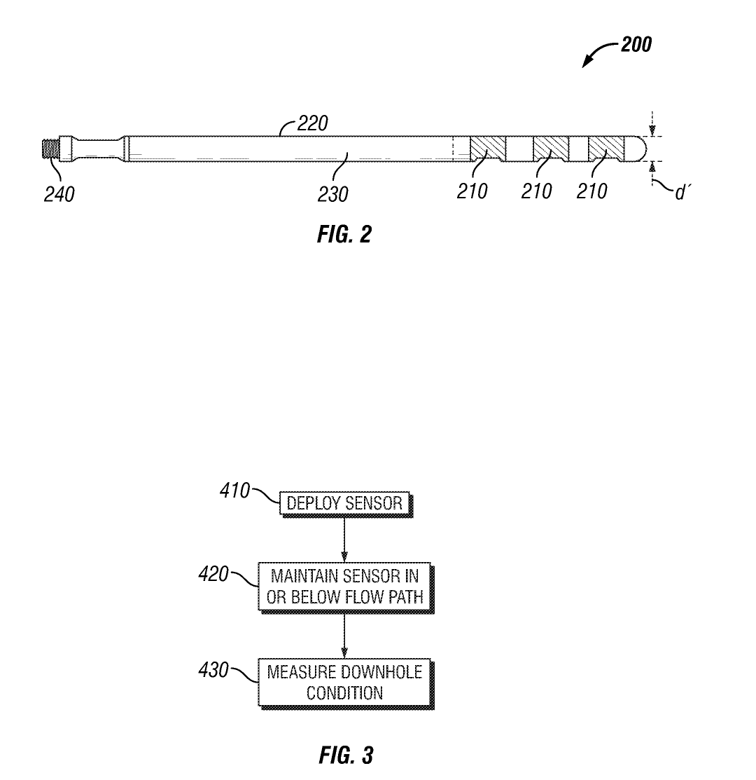

At the bottom end of the conveyance device 100, there is connected a slim downhole sensor device, which is generally referred to as 200 in FIG. 1 and further illustrated in FIG. 2 below. The slim downhole sensor device 200 comprises one or more sensors 210 and an elongated housing 220 accommodating the sensors 210. The elongated housing can be substantially cylindrical, as shown in FIGS. 1 and 2 of the current application, or in any other shape suitable for oilfield operations. A connector 240 is provided at one end of the downhole sensor device 200 to form an appropriate connection with the conveyance device 100. The connecting mechanism can be any one recognized by people skilled in the art such as hooks, screws, threads, slips, pins, dimple connections, etc.

The sensors 210 contained in the slim downhole sensor device 200 can be any type of sensors capable of operating under the temperature and pressure at the downhole location. The parameters monitored by the sensors 210 can be anything of interest to the oilfield operator, such as temperature, pressure, fluid density, flow rate, viscosity, etc. In some cases, different sensors 210 such as a temperature sensor and a pressure sensor are positioned into different cavities in the housing 220, as shown in FIGS. 1 and 2 of the application. In some other cases, multiple sensors 210 can be arranged in a single cavity in the housing 220, therefore reducing the length of the slim downhole sensor device 200. Furthermore, with the development of multi-purpose sensors, it is possible to have one sensor 210 recording multiple parameters such as pressure and temperature or density and viscosity. All such variations should be considered within the scope of the current application.

In some cases, the elongated housing 220 may further contain a compartment 230 to accommodate supporting devices such as battery, data storage device, telemetry or communication device, etc. The battery can be used to supply powers to the sensors 210. The data storage device can be used to temporarily store the data acquired by the sensors 210. The telemetry or communication device can be used to transmit the data to the surface of the wellbore or receive instructions from the surface of the wellbore. Other devices can be placed in the elongated housing 220 as well.

In some cases, the data acquired by the sensors 210 are transmitted to the surface of the oilfield immediately for real time monitoring or analyzing. The data transmission can be accomplished by an appropriate conveyance device 100 such as a wireline or by a wireless means such as fluid pulse telemetry. In some other cases, data acquired by the sensors 210 are temporarily stored in the data storage device located in the elongated housing 220 of the slim downhole sensor device 200, and downloaded to a computer after the slim downhole sensor device 200 is pulled out of the wellbore 10 for post-operation analyses. In yet some other cases, data acquired by the sensors 210 are used in both real time monitoring and post-operation analyses. All such variations should be considered within the scope of the current application.

During an oilfield operation such as a hydraulic fracturing operation or an acid treatment operation, a treatment fluid is introduced through the conduit 60, treatment head 50, treatment pipe 40, BOP 30, wellbore 10, and eventually the treatment zone 300 of the subterranean formation 20. The treatment fluid is typically pumped into the system under an elevated pressure and at a high flow rate, therefore creating a significant drag force on any object positioned in the flow path of the treatment fluid. Many conveyance devices 100, such as cables or wireline, cannot sustain very high drag forces. Beyond a certain level, the conveyance device 100 will be damaged or break, leaving the tool connected to the conveyance device 100 in the wellbore 10. In severe conditions, if the lost tool cannot be successfully removed, the entire well may be in jeopardy. Therefore, it is generally undesirable to position a downhole device attached to the bottom of a conveyance device 100 inside the flow path of the treatment fluid.

According to one aspect of the current application, there is provided a slim downhole sensor device 200 that is connected to the bottom of a conveyance device 100, where the slim downhole sensor device 200 is positioned inside the flow path of the treatment fluid. To prevent the conveyance device 100 from damage or breaking apart due to the drag force caused by the treatment fluid, the diameter of the downhole sensor device 200 is reduced and/or the flow rate of the treatment fluid is controlled, for example, according to the equation set forth below:

F_{d}=C_{d} ½ ρ v² A (Equation I)

where:

F_{d}=drag force

c_{d}=drag coefficient

ρ=density of the fluid

v=flow velocity

A=characteristic frontal area of the tool.

Other methods such as numerical analysis or fluid dynamic calculations known to people skilled in the art can also be used.

For example, when pumping a moderately viscous fluid into a 4.5″ cased well at a pumping rate of about 35 bbl/day, a 0.32″ wireline can support a tool with an outer diameter of no more than 2″ without risking the wireline from breaking apart. In one specific embodiment, the slim downhole sensor device 200 is 404 mm in length and 19.05 mm in outer diameter.

Referring back to FIGS. 1 and 2, in some cases of the current application, the outer diameter (d′) of the elongated housing 220 is about 10% to about 70% of the inner diameter (d″) of the flow path of the treatment fluid applied to the wellbore 10. In some other cases, the outer diameter (d′) of the elongated housing 220 is about 20% to about 60% of the inner diameter (d″) of the flow path of the treatment fluid applied to the wellbore 10. In some further cases, the outer diameter (d′) of the elongated housing 220 is about 30% to about 50% of the inner diameter (d″) of the flow path of the treatment fluid applied to the wellbore 10. In some even further cases, the outer diameter (d′) of the elongated housing 220 is about 40% of the inner diameter (d″) of the flow path of the treatment fluid applied to the wellbore 10.

Referring now to FIG. 3 of the application, there is provided a method of monitoring downhole conditions, where a slim downhole sensor device 200 of the current application can be deployed to a downhole position proximate to a treatment zone 300 of the subterranean formation 20, generally indicated by block 410 in FIG. 3. The treatment fluid is then pumped into the wellbore 10 and the slim downhole sensor device 200 is maintained inside the flow path of the treatment fluid, generally indicated by block 420 in FIG. 3. The sensors 210 of the slim downhole sensor device 200 measure the downhole condition at a close proximity to the treatment zone 300 (above, next to, or below the treatment zone 300) and below or within the flow path of the treatment fluid, generally indicated by block 430 in FIG. 3, therefore more accurately recording parameters of the treatment operation.

In some cases, the method may further comprise controlling the flow rate of the treatment fluid at an acceptable level so that the drag force exerted by the treatment fluid is below the maximum bearing capability of the conveyance device 100. Equation I recited above (or other acceptable mathematic analyses or fluid dynamic calculations) can be used to determine the acceptable flow rate of the treatment fluid.

In some other cases, the method may further comprise configuring the downhole sensor device 200 to have an outer diameter that is no more than a maximum diameter allowable under a given treatment condition (such as flow rate, fluid type, etc.) so as to prevent the conveyance device 100 from being damaged or broke apart. Equation I recited above (or other acceptable mathematic analyses or fluid dynamic calculations) can be used to determine the maximum diameter of the downhole sensor device 200 under a given treatment condition. In some cases, the maximum diameter determined by Equation I is about 70% of the inner diameter of the flow path of the treatment fluid applied to the treatment zone. In some other cases, the maximum diameter determined by Equation I is about 60%, 50%, 40%, 30%, 20% or 10% of the inner diameter of the flow path of the treatment fluid applied to the treatment zone.

In some further cases, the method may further comprise providing a blast joint 70 located proximate to the entry of the treatment fluid into the treatment head 50 so as to prevent the treatment fluid from directly impacting the conveyance device by erosion or jetting action. In yet some further cases, more than one of the controlling the flow rate of the treatment fluid, configuring the outer diameter of the downhole sensor device 200, and providing a blast joint 70 at a location proximate to the entry of the treatment fluid into the treatment head 50 are utilized to minimize potential damages to the conveyance device 100.

In some cases, the slim downhole sensor device 200 is deployed in the middle of the treatment fluid stream. In some other cases, the slim downhole sensor device 200 is deviated from the middle of the treatment fluid stream. In some further cases, the slim downhole sensor device 200 is in physical contact with the wall of the wellbore 10, therefore reducing the negative impact caused by the fluctuation and pulsation of the treatment fluid on the slim downhole sensor device 200 and meanwhile still maintaining the slim downhole sensor device 200 within the flow path of the treatment fluid. There are many mechanisms to deviate the slim downhole sensor device 200 from the middle of the treatment fluid stream and eventually cause the slim downhole sensor device 200 to be in physical contact with the wall of the wellbore 10. For example, in one embodiment, the slim downhole sensor device 200 contains a magnetic device (not shown) that is located inside the compartment 230 of the elongated housing 220. When the slim downhole sensor device 200 is deployed in a casing-lined wellbore, the magnetic force exerted by the magnetic device pulls the slim downhole sensor device 200 towards the metal casing. The magnetic device can exert a permanent magnetic force or can be activated as desired, for example with the use electromagnets or displacement of magnets or shielding devices.

The preceding description has been presented with reference to some illustrative embodiments of the current application. Variations and modifications therefrom exist. Any number disclosed herein should be construed to mean approximate, regardless of whether the word “about” or “approximate” is used in describing the number. Persons skilled in the art and technology to which this application pertains will appreciate that alterations and changes in the described structures and methods of operation can be practiced without meaningfully departing from the principle, and scope of this application. Accordingly, the foregoing description should not be read as pertaining only to the precise structures described and shown in the accompanying drawings, but rather should be read as consistent with and as support for the following claims, which are to have their fullest and fairest scope.

What is claimed is:

1. An assembly comprising:
a sensor hosted in an elongated housing,
a conveyance device that is attached to the elongated housing at one end and to a surface of a wellbore at another end;
wherein an outer diameter of the elongated housing is about 10% to about 70% of an inner diameter of a flow path of a treatment fluid applied to the wellbore.

2. The assembly of claim 1, wherein the outer diameter of the elongated housing is about 20% to 60% of the inner diameter of the flow path of the treatment fluid applied to the wellbore.

3. The assembly of claim 2, wherein the outer diameter of the elongated housing is about 30% to 50% of the inner diameter of the flow path of the treatment fluid applied to the wellbore.

4. The assembly of claim 3, wherein the outer diameter of the elongated housing is about 40% of the inner diameter of the flow path of the treatment fluid applied to the wellbore.

5. The assembly of claim 1, wherein said treatment is a hydraulic fracturing treatment and said treatment fluid is a fracturing fluid.

6. The assembly of claim 1, further comprising a blast joint located proximate to an entry of the treatment fluid, said blast joint prevents the treatment fluid from directly impacting the conveyance device.

7. The assembly of claim 6, wherein the blast joint is a stinger blast joint.

8. The assembly of claim 1, wherein the conveyance device is one of a coiled tubing, a wireline, a slickline, or a cable.

9. A device, comprising:
a sensor;
an elongated housing accommodating the sensor;
wherein a ratio of the outer diameter of the elongated housing to the inner diameter of a flow path of a treatment fluid applied to a wellbore within which the slim downhole sensor is deployed is from about 0.10 to about 0.70.

10. The slim downhole sensor device of claim 11, wherein ratio of the outer diameter of the elongated housing to the inner diameter of the flow path of the treatment fluid is from about 0.20 to about 0.60.

11. The slim downhole sensor device of claim 11, wherein ratio of the outer diameter of the elongated housing to the inner diameter of the flow path of the treatment fluid is from about 0.30 to about 0.50.

12. The slim downhole sensor device of claim 11, wherein ratio of the outer diameter of the elongated housing to the inner diameter of the flow path of the treatment fluid is about 0.40.

13. A method of monitoring a downhole condition proximate to a treatment zone of a subterranean formation, said method comprising:
deploying a sensor to a position proximate to the treatment zone of the subterranean formation;
maintaining the sensor below or within a flow path of a treatment fluid applied to the treatment zone; and
recording a measurement by the sensor.

14. The method of claim 13, wherein said deploying of the sensor is achieved by one of a coiled tubing, a wireline, a slickline, or a cable.

15. The method of claim 13, wherein the sensor measures one or more of a temperature, a pressure, a viscosity, a density, and a flow rate of a treatment fluid applied to the treatment zone.

16. The method of claim 13, further comprising maintaining a flow rate of the treatment fluid at a level no greater than a maximum flow rate determined by:
F_{d}=c_{d} ½ ρ v² A (Equation I)
wherein:
F_{d}=drag force on the sensor;
c_{d}=drag coefficient;
ρ=density of the treatment fluid;
v=flow velocity of the treatment fluid; and
A=characteristic frontal area of the sensor.

17. The method of claim 13, further comprising configuring an outer diameter of the sensor to be no greater than a maximum diameter determined by:
F_{d}=c_{d} ½ ρ v² A (Equation I)
wherein:
F_{d}=drag force on the sensor;
c_{d}=drag coefficient;
ρ=density of the treatment fluid;
v=flow velocity of the treatment fluid; and
A=characteristic frontal area of the sensor.

18. The method of claim 17, wherein the maximum diameter determined by Equation I is about 70% of an inner diameter of a flow path of a treatment fluid applied to the treatment zone.

19. The method of claim 18, wherein the maximum diameter determined by Equation I is about 50% of the inner diameter of the flow path of the treatment fluid applied to the treatment zone.

20. The method of claim 19, wherein the maximum diameter determined by Equation I is about 30% of the inner diameter of the flow path of the treatment fluid applied to the treatment zone.

21. The method of claim 18, wherein the maximum diameter determined by Equation I is about 10% of the inner diameter of the flow path of the treatment fluid applied to the treatment zone.

22. The method of claim 13, further comprising providing a blast joint 70 proximate to a location where the treatment fluid enters into a wellbore penetrating the subterranean formation.

23. The method of claim 13, wherein the sensor contacts a wall of a wellbore penetrating the subterranean formation.
